(19) United States
(12) Patent Application Publication
(10) Pub. No.: US 2017/0176602 A1
(43) Pub. Date: Jun. 22, 2017

(54) APPARATUS FOR IDENTIFYING LOCATION OF USER

(71) Applicant: ELECTRONICS AND TELECOMMUNICATIONS RESEARCH INSTITUTE, Daejeon (KR)

(72) Inventors: Eun Seo LEE, Daejeon (KR); Jun Hee PARK, Daejeon (KR)

(21) Appl. No.: 15/379,719

(22) Filed: Dec. 15, 2016

(30) Foreign Application Priority Data
Dec. 21, 2015 (KR) 10-2015-0183170

(51) Int. Cl. G01S 19/46; H04W 76/02; G01S 19/26; H04W 72/10

(52) U.S. Cl. CPC G01S 19/46; H04W 72/10; H04W 76/021; G01S 19/26; H04L 61/2007

(57) ABSTRACT

A terminal for identifying a location of a user includes a transmitter configured to transmit data, a receiver configured to receive the data, a sensor configured to sense at least one piece of context information, and a controller configured to determine a priority order of area information, service set identifier (SSID) information, global positioning system (GPS) signal information, and the context information corresponding to each location, identify the location based on the priority order, and determine the priority order of the SSID information and the GPS signal information in response to retrieving a number of SSIDs.

### CROSS-REFERENCE TO RELATED APPLICATION(S)

This application claims the priority benefit of Korean Patent Application No. 10-2015-0183170 filed on Dec. 21, 2015, in the Korean Intellectual Property Office, the disclosure of which is incorporated herein by reference for all purposes.

### BACKGROUND

1. Field

One or more example embodiments relate to an apparatus for identifying a location of a user, and more particularly, to an apparatus for accurately identifying a location of a user based on various pieces of information.

2. Description of Related Art

Recently, expectations are increasing for internet of things (IoT) technology, and thus various smart devices for providing IoT services have been developed. However, a passive IoT service that is provided only allows a user to monitor and remotely control a smart device, and dynamic IoT services that are provided and do recognize a circumstance of a user are still inadequate. Still, it is estimated that the IoT world may provide a user with various services by connecting smart devices to the Internet.

Context information of a user may be important for the purpose of providing an IoT service. The context information of the user may include a location, time, and emotional condition of the user. Even though global positioning system (GPS) information and base station information are used to identify a location of the user, an error range of such information is relatively great and thus it is difficult to identify an accurate location of the user thereby.

### SUMMARY

An aspect provides an apparatus for accurately identifying a location of a user.

Another aspect also provides an apparatus for identifying a location of a user based on information on an area in which a user is located, global positioning system (GPS) information, and context information.

Still another aspect also provides an apparatus for identifying a user based on a priority order of various pieces of information.

According to an aspect, there is provided a terminal for identifying a location of a user including a transmitter configured to transmit data, a receiver configured to receive the data, a sensor configured to sense at least one piece of context information, and a controller configured to determine a priority order of service set identifier (SSID) information, global positioning system (GPS) signal information, the context information, and area information corresponding to each location, identify the location based on the priority order, and determine the priority order of the SSID information and the GPS signal information in response to retrieving a number of SSIDs.

The controller may be configured to store at least one of the SSID information, the GPS signal information, the context information, or the area information on the location based on the priority order.

When the controller searches for the location, the controller may be configured to identify the location by searching for information within a predetermined range and the at least one of the SSID information, the GPS signal information, the context information, or the area information on the location, based on the priority order.

The controller may be configured to assign a higher priority to the SSID information than the GPS signal information when the number of retrieved SSIDs is greater than or equal to 2.

The controller may be configured to assign a highest priority to the area information, and the SSID information may include a name and a signal intensity of an SSID.

The context information may include at least one of temperature, humidity, time, or weather. The area information may be classified into area information received when the terminal is connected using a long distance wireless communication method and internet protocol (IP) information received when the terminal is connected using a short distance wireless communication method, and the controller may be configured to assign a higher priority to the IP information received when the terminal is connected using the short distance wireless communication method than the area information received when the terminal is connected using the long distance wireless communication method.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a configuration of a communication system according to an example embodiment;

FIG. 2 is a block diagram illustrating a terminal according to an example embodiment;

FIG. 3 is a flowchart illustrating a process of determining a priority order of information for identifying a location by a terminal according to an example embodiment; and

FIG. 4 is a flowchart illustrating a process of identifying a location of a user based on a priority order of pieces of information by a terminal according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

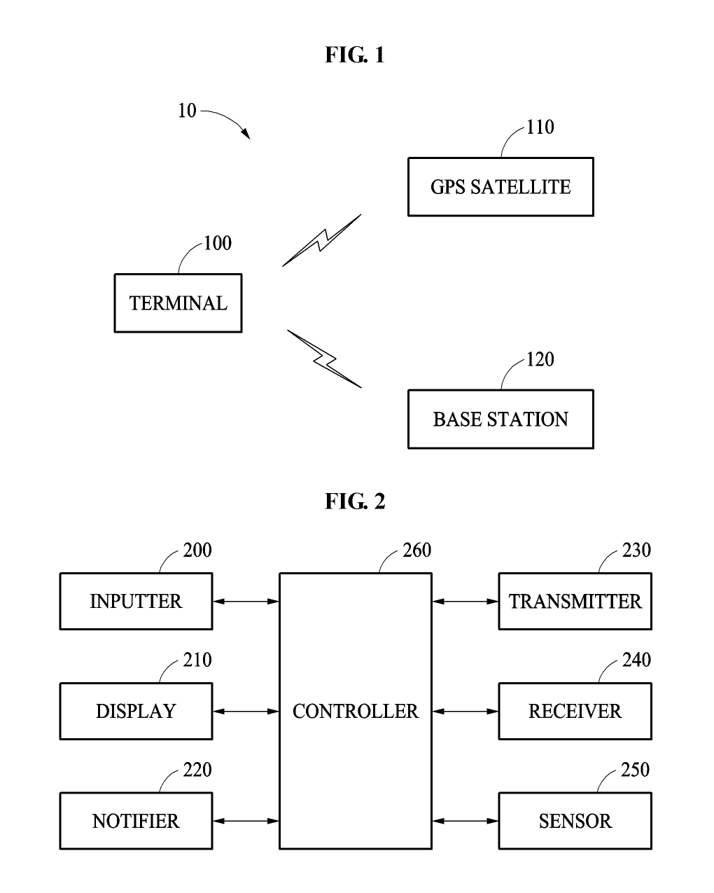

FIG. 1 is a diagram illustrating a configuration of a communication system 10 according to an example embodiment.

Referring to FIG. 1, the communication system 10 includes a terminal 100, a global positioning system (GPS) satellite 110, and a base station 120. The communication system 10 may further include an access point (AP) (not shown).

The terminal 100 communicates with the GPS satellite 110 and the base station 120, receives area information on an area in which the terminal 100 is located from the base station 120, and receives a GPS signal from the GPS satellite 110. Because the terminal 100 includes various sensors, the terminal 100 may sense temperature, humidity, and illuminance and receive various pieces of environment information, for example, weather information, from an external source. The terminal 100 may be a mobile device such as a smartphone, a smartwatch, and a smartpad.

The base station 120 may connect the terminal 100 and a communication network such that the terminal 100 communicates with the external source, and the AP may allow the terminal 100 to perform Wi-Fi communication.

The GPS satellite 110 may be variously used as a satellite for identifying a location for civilian and military purposes. For example, the GPS satellite 110 may be used for guided weapons, navigation, measurement, cartography, land surveying, and map synchronization. The GPS satellite 110 may transmit frequencies indicating location information such that a notification about a location of a ship, a location of an airplane, and a location of an individual may be provided.

FIG. 2 is a block diagram illustrating the terminal 100 according to an example embodiment.

Referring to FIG. 2, the terminal 100 includes an inputter 200, a display 210, a notifier 220, a transmitter 230, a receiver 240, a sensor 250, and a controller 260.

The inputter 200 receives data from a user and the display 210 displays the data. The inputter 200 and the display 210 may include a touch panel or a touch screen.

The notifier 220 notifies the user of information using a sound, vibration, and light. For example, when the user stores a location in a predetermined area and then arrives at the location, the user may be notified by a sound. The notifier 220 may include a speaker, a vibration motor, and a light emitting diode (LED).

The receiver 240 receives data and the transmitter 230 transmits the data. For example, the transmitter 230 may transmit the data to an external source through the base station 120, and the receiver 230 may receive area information from the base station 120, receive a WiFi signal from an access point (AP), and receive a global positioning system (GPS) signal from the GPS satellite 110. The transmitter 230 and the receiver 240 may communicate with the external source using various wireless communication methods, for example, a Bluetooth technology, a WiFi technology, a WiBro technology, a third generation (3G) wideband code division multiple access (WCDMA) technology, a long term evolution (LTE) technology, and a fourth generation (4G) communication technology, in addition to a wired communication method.

The sensor 250 may sense various pieces of context information and include an illumination sensor, a proximity sensor, a geomagnetic sensor, a gravity sensor, an acceleration sensor, a gyro sensor, a temperature sensor, and a humidity sensor.

The controller 260 may verify a signal intensity and a name of a service set identifier (SSID), store information by determining a priority order of SSID information and GPS information for identifying a location of a user, and search for the location of the user based on the stored information, such that the terminal 100 is controlled by the controller 230.

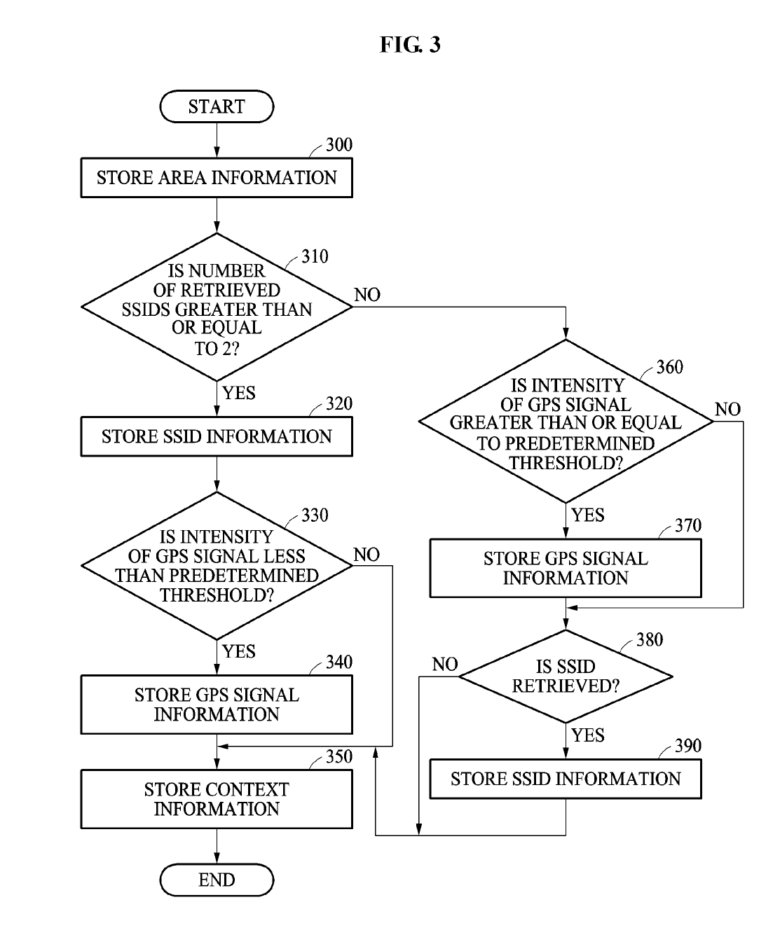

FIG. 3 is a flowchart illustrating a process of determining a priority order of information for identifying a location by the terminal 100 according to an example embodiment.

The terminal 100 may use area information, service set identifier (SSID) information, global positioning system (GPS) information, and context information as information for identifying a location, store and determine a priority order of pieces of information on each location, and search for the location based on the priority order of the information on each location when a predetermined location is retrieved. For example, when a user performs logging on a predetermined location, the controller 260 may determine the priority order of the context information, the GPS information, the SSID information, and the area information on the location, store each of the context information, the GPS information, the SSID information, and the area information, and search for the location based on the priority order when searching for the location.

In a process of determining the priority order of information for identifying the location, the terminal 100 may store the area information on the location, search for an SSID to verify whether a plurality of SSIDs is present, and lastly store the context information when the user performs logging on the predetermined location. Here, the context information may include temperature, humidity, time, and weather. The area information may be classified into area information received when the terminal 100 is connected using a 3G technology, a 4G technology, and an LTE technology, and internet protocol (IP) information received when the terminal 100 is connected using a WiFi technology. A higher priority may be assigned to the IP information received when the terminal 100 is connected using the WiFi technology than the area information received when the terminal 100 is connected using the 3G technology.

The area information may be stored first and the context information may be stored last. The priority order of the SSID information and the GPS information may differ based on a condition. Here, the condition may be determined in advance, and the user may change the condition. For example, the terminal 100 may determine the priority order based on whether a number of retrieved SSIDs is greater than or equal to 2 and whether an intensity of a GPS signal is greater than or equal to a predetermined threshold.

Referring to FIG. 3, in operation 300, the terminal 100 stores the area information. When the number of the retrieved SSIDs is greater than or equal to 2 (Yes in operation 310), the terminal 100 stores the SSID information including the name and the signal intensity of each of the SSIDs in operation 320, and then verifies whether the intensity of the GPS signal is greater than or equal to the predetermined threshold. When the intensity of the GPS signal is greater than or equal to the predetermined threshold (yes in operation 330), the terminal 100 stores the GPS signal information in operation 340 and then stores the context information in operation 350. When the intensity of the GPS signal is less than the predetermined threshold (no in operation 330), the terminal 100 stores the context information instead of storing the GPS signal information in operation 350.

When the number of SSIDs is less than 2 (no in operation 310), the terminal 100 verifies whether the intensity of the GPS signal is greater than or equal to the predetermined threshold. When the intensity of the GPS signal is greater than or equal to the predetermined threshold (yes in operation 360), the terminal 100 stores the GPS signal information in operation 370. Subsequently, when the SSID is retrieved (yes in operation 380), the terminal 100 stores the SSID information including the name and the signal intensity of the retrieved SSID in operation 390, and then stores the context information in operation 350. When the SSID is not retrieved (no in operation 380), the terminal 100 only stores the context information in operation 350. When the intensity of the GPS signal is less than the predetermined threshold (no in operation 360), the terminal 100 does not store the GPS signal information. When the SSID is retrieved (yes in operation 380), the terminal 100 stores the SSID information including the name and the signal intensity of the retrieved SSID in operation 390 and then stores the context information in operation 350. When the SSID is not retrieved (no in operation 380), the terminal 100 only stores the context information in operation 350.

The user may determine the priority order of each piece of context information, and each piece of context information may be stored based on the priority order determined by the user. Each piece of information may be retrieved based on the priority order stored when the location is retrieved.

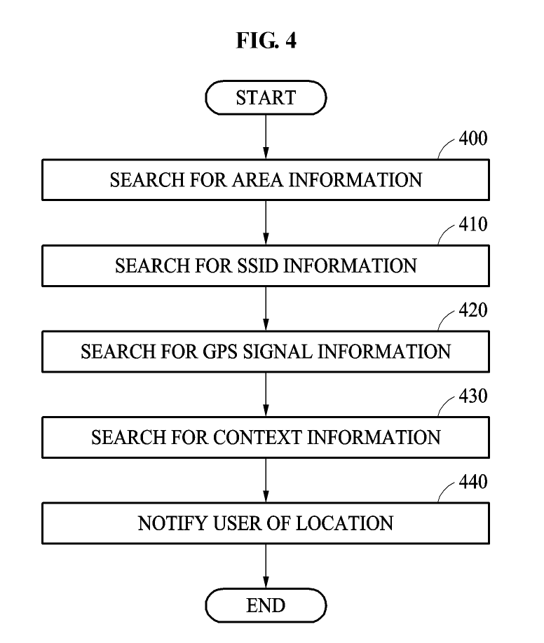

FIG. 4 is a flowchart illustrating a process of identifying a location of a user based on a priority order of pieces of information by the terminal 100 according to an example embodiment.

FIG. 4 illustrates a process of searching for a location when information on a predetermined location is stored in an order of area information, SSID information, GPS signal information, and context information. Here, when the priority order of each piece of information on a predetermined location is differently assigned and stored, searching may be performed based on the priority order stored when the location is retrieved.

Referring to FIG. 4, when a user searches for the location, the terminal 100 firstly searches for area information by comparing the area information received from the base station 120 to the area information that is stored in operation 400. When the area information received from the base station 120 and the stored area information are identical, the terminal searches for the SSID information and verifies whether an SSID of which a name and a signal intensity are identical to those of a stored SSID in operation 410. When the SSID of which the name and the signal intensity are identical to those of the stored SSID is retrieved, the terminal 100 may verify GPS signal information. When the SSID of which the name and the signal intensity are identical to those of the stored SSID is not retrieved, the terminal 100 may continuously search for the SSID. When the SSID of which the name and the signal intensity are identical to those of the stored SSID is retrieved, the terminal 100 searches for the GPS signal information received from the GPS satellite 110 and verifies whether information identical to the stored GPS signal information is present in operation 420. When the identical GPS signal information is retrieved, the terminal 100 searches for context information identical to stored? context information. When the identical GPS signal information is not retrieved, the terminal 100 continuously searches for the GPS signal information. When the identical GPS signal information is retrieved, the terminal 100 searches for the context information and verifies whether context information identical to stored? context information is present. When the context information identical to the stored? context information is not retrieved, the terminal 100 continuously searches for the context information in operation 430. When the context information identical to the stored? context information is retrieved, the terminal 100 may notify the user of a location identical to the location stored by the user through the notifier 220 or the display 210 in operation 440.

The terminal 100 may verify that retrieved information is identical to information stored when the area information, the SSID information, the GPS signal information, and the context information are retrieved in response to an error range of the stored information and the retrieved information being within a predetermined range. The error range may be determined in advance or determined by a selection of the user. For example, values of pieces of information, for example, a signal intensity of an SSID, GPS coordinates, a GPS signal intensity, and a context, may be verified to determine whether they are in the predetermined range of identity.

According to an aspect, it is possible to accurately identify a location of a user by determining a priority order of area information, service set identifier (SSID) information, global positioning system (GPS) signal information, and the context information received from a base station, storing a location of a user based on the priority order, and identifying the location of the user based on the priority order.

According to another aspect, it is possible to prevent power from being unnecessarily consumed by identifying a location of a user based on a determined priority order because it is unnecessary to search for information to which a relatively low priority is assigned when information to which a relatively high priority is assigned has not yet been retrieved.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A terminal for identifying a location of a user, the terminal comprising:
a transmitter configured to transmit data;
a receiver configured to receive the data;
a sensor configured to sense at least one piece of context information; and
a controller configured to determine a priority order of service set identifier (SSID) information, global positioning system (GPS) signal information, the context information, and area information corresponding to each location, identify the location based on the priority order, and determine the priority order of the SSID information and the GPS signal information in response to retrieving a number of SSIDs.

2. The terminal of claim 1, wherein the controller is configured to store at least one of the SSID information, the GPS signal information, the context information, or the area information on the location based on the priority order.

3. The terminal of claim 2, wherein, when the controller searches for the location, the controller is configured to identify the location by searching for information within a predetermined range and the at least one of the SSID information, the GPS signal information, the context information, or the area information on the location, based on the priority order.

4. The terminal of claim 1, wherein the controller is configured to assign a higher priority to the SSID information than the GPS signal information when the number of retrieved SSIDs is greater than or equal to 2.

5. The terminal of claim 1, wherein the controller is configured to assign a highest priority to the area information.

6. The terminal of claim 1, wherein the SSID information includes a name and a signal intensity of an SSID.

7. The terminal of claim 1, wherein the context information includes at least one of temperature, humidity, time, or weather.

8. The terminal of claim 1, wherein the area information is classified into area information received when the terminal is connected using a long distance wireless communication method and internet protocol (IP) information received when the terminal is connected using a short distance wireless communication method, and
the controller is configured to assign a higher priority to the IP information received when the terminal is connected using the short distance wireless communication method than the area information received when the terminal is connected using the long distance wireless communication method.
